(19) United States
(12) Patent Application Publication
(10) Pub. No.: US 2021/0272362 A1
(43) Pub. Date: Sep. 2, 2021

(54) OVEN APPLIANCE AND AUGMENTED REALITY CONTROL FEATURES

(71) Applicant: Haier US Appliance Solutions, Inc., Wilmington, DE (US)

(72) Inventor: Seung-Yeong Park, Seongnam (KR)

(21) Appl. No.: 16/802,804

(22) Filed: Feb. 27, 2020

(51) Int. Cl. G06T 19/00; G06F 9/451; G05B 19/042; G06F 3/0484; H04L 12/28; F27D 21/02

(52) U.S. Cl. CPC G06T 19/006; G06F 9/452; G05B 19/042; G06F 3/0484; H04N 5/2253; F27D 21/02; G05B 2219/2642; H04L 2012/2841; H04L 12/282

(57) ABSTRACT

A user engagement system for an oven appliance, as provided herein, may include a camera assembly, an image monitor, and a controller. The camera assembly may be directed at a cooking zone. The image monitor may be spaced apart from the cooking zone. The controller may be configured to initiate a directed cooking operation including generating an oven avatar on the image monitor to provide a virtual representation of the oven appliance. The oven avatar may include a virtual zone corresponding to the cooking zone. The directed cooking operation may further include receiving a video signal of the cooking zone from the camera assembly and presenting a real-time feed of the cooking zone at the virtual zone. The directed cooking operation may still further include receiving a control input at the oven avatar, and directing the oven appliance based on the control input received at the oven avatar.

### FIELD OF THE INVENTION

The present subject matter relates generally to systems and methods for controlling an oven appliance.

### BACKGROUND OF THE INVENTION

Oven appliances, such as cooktop or range appliances, generally include heating elements for heating cooking utensils, such as pots, pans and griddles. A variety of configurations can be used for the heating elements located on the cooking surface of the cooktop. The number of heating elements or positions available for heating on the range appliance can include, for example, four, six, or more depending upon the intended application and preferences of the buyer. These heating elements can vary in size, location, and capability across the appliance. Similarly, a variety of configurations can be used for heating elements located within a cabinet or cooking chamber of an oven. Conventional oven appliances include a top “broil” heating element and a bottom “baking” heating element within a cooking chamber.

Users can operate an oven appliance to cook food items as desired by selecting or manipulating various operational features of the oven appliance, such as the temperature setting or mode of operation (e.g., bake, broil, etc.). In some instances, users may desire to select or manipulate these operational features remotely or “hands free.” Some oven appliances may include a “remote enable” mode that allows users to remotely modify operational features of the oven appliance (e.g., on a separate user device). Nonetheless, the exact size, location, and capability within the appliance may vary.

Although remote operation of the oven appliance may provide greater freedom and flexibility for a user, existing implementations are often unsatisfactory. For instance, the interface or controls that are presented on a separate user device are typically unintuitive and can be difficult for users to discern. Moreover, a user is generally unable to know whether a selected instruction or input has been received, let alone, executed by the oven appliance.

As a result, improved systems are needed for facilitating control (e.g., remote control) of an oven appliance. In particular, it may be advantageous to provide systems or methods that are readily intuitive for users to control a oven appliance. Additionally or alternatively, it may be advantageous to provide systems or methods for remote control of an oven appliance that provide direct feedback or information on the state of the oven appliance

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method operating an oven appliance at a remote user interface device is provided. The method may include generating an oven avatar on an image monitor to provide a virtual representation of an oven appliance. The oven avatar may include a virtual zone corresponding to a cooking zone of the oven appliance. The method may further include receiving a video signal of the cooking zone from a camera and presenting a real-time feed of the cooking zone at the virtual zone. The method may still further include receiving a control input at the oven avatar, and directing the oven appliance based on the control input received at the oven avatar.

In another exemplary aspect of the present disclosure, a user engagement system is provided. The user engagement system may include a camera assembly, an image monitor, and a controller. The camera assembly may be directed at a cooking zone of an oven appliance. The image monitor may be spaced apart from the cooking zone. The controller may be in operative communication with the camera assembly and the image monitor. The controller may be configured to initiate a directed cooking operation. The directed cooking operation may include generating an oven avatar on the image monitor to provide a virtual representation of the oven appliance. The oven avatar may include a virtual zone corresponding to the cooking zone. The directed cooking operation may further include receiving a video signal of the cooking zone from the camera assembly and presenting a real-time feed of the cooking zone at the virtual zone. The directed cooking operation may still further include receiving a control input at the oven avatar, and directing the oven appliance based on the control input received at the oven avatar.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of a system according to exemplary embodiments of the present disclosure.

FIG. 2 provides a side schematic view of the exemplary system of FIG. 1.

FIG. 3 provides a schematic view of a system for engaging an oven appliance according to exemplary embodiments of the present disclosure.

FIG. 4 provides a front perspective view of a system according to exemplary embodiments of the present disclosure.

FIG. 5 provides a flow chart illustrating a method of operating a system according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

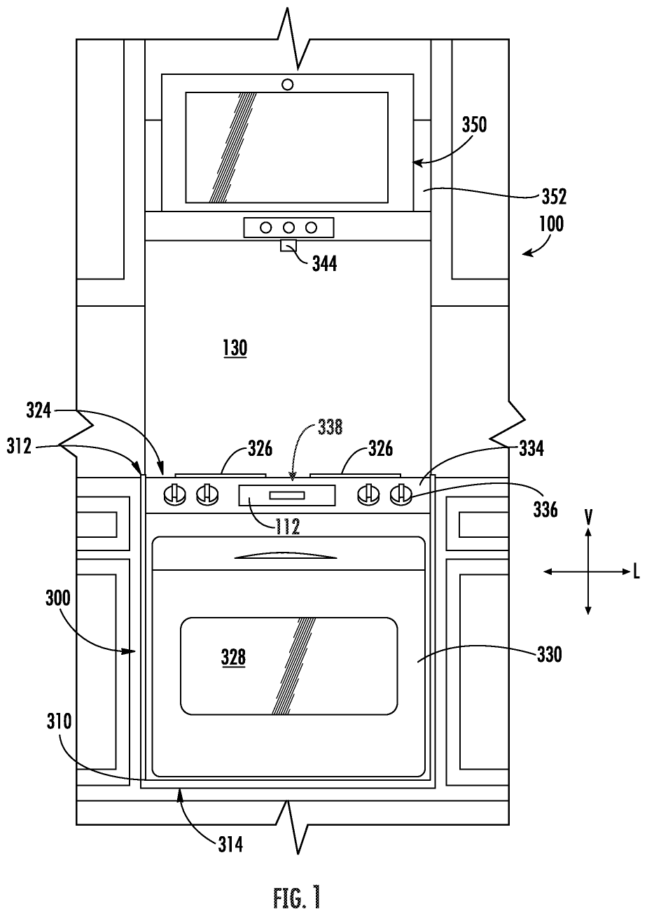

Turning now to the figures, FIGS. 1 through 3 provide various views of a system (e.g., user engagement system 100) for coordinating and controlling an oven appliance 300, such as a cooktop appliance, according to exemplary embodiments of the present disclosure. Along with oven appliance 300, system 100 generally includes a remote server 404 and one or more user devices 408, as will be further described below.

As shown oven appliance 300 defines a vertical direction V, a lateral direction L, and a transverse direction T, for example, at a cabinet 310. The vertical, lateral, and transverse directions are mutually perpendicular and form an orthogonal direction system. As shown, oven appliance 300 extends along the vertical direction V between a top portion 312 and a bottom portion 314; along the lateral direction L between a left side portion and a right side portion; and along the traverse direction T between a front portion and a rear portion.

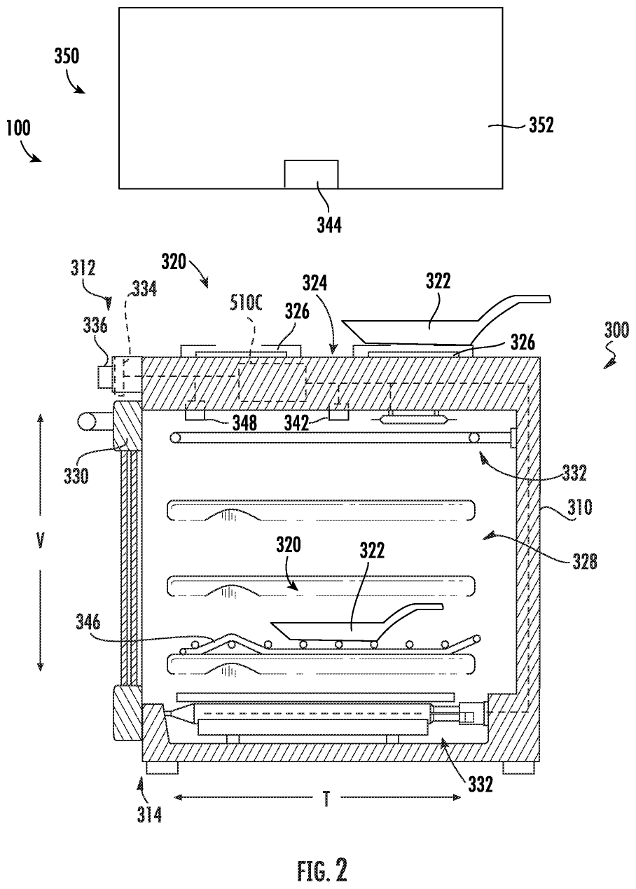

Oven appliance 300 can include a chassis or cabinet 310 and a cooktop surface 324 having one or more heating elements 326 for use in, for example, heating or cooking operations. In exemplary embodiments, cooktop surface 324 is constructed with ceramic glass. In other embodiments, however, cooktop surface 324 may include of another suitable material, such as a metallic material (e.g., steel) or another suitable non-metallic material. Heating elements 326 may be various sizes and may employ any suitable method for heating or cooking an object, such as a cooking utensil 322, and its contents. In some embodiments, for example, heating element 326 uses a heat transfer method, such as electric coils or gas burners, to heat the cooking utensil. In alternative embodiments, however, heating element 326 uses an induction heating method to heat the cooking utensil 322 directly. In turn, heating element 326 may include a gas burner element, resistive heat element, radiant heat element, induction element, or another suitable heating element. Moreover, when the oven appliance 300 is illustrated as having a cooktop surface 324 in FIGS. 1 and 2, it is understood that alternative embodiments may be provided without a cooktop.

In some embodiments, oven appliance 300 includes an insulated cabinet 310 that defines a cooking chamber 328 selectively covered by a door 330. One or more heating elements 332 (e.g., top broiling element or bottom baking element) may be enclosed within cabinet 310 to heat cooking chamber 328. Heating elements 332 within cooking chamber 328 may be provided as any suitable element for cooking the contents of cooking chamber 328 (e.g., a utensil 322 within cooking chamber 328), such as an electric resistive heating element, a gas burner, microwave element, halogen element, etc. Thus, oven appliance 300 may be referred to as an oven range appliance. As will be understood by those skilled in the art, oven appliance 300 is provided by way of example only, and the present subject matter may be used in any suitable oven appliance 300, such as a double oven range appliance or a standalone cooktop (e.g., fitted integrally with a surface of a kitchen counter). Thus, the exemplary embodiments illustrated in the figures are not intended to limit the present subject matter to any particular cooking chamber or heating element configuration, except as otherwise indicated.

Generally, oven appliance 300 includes a controller 510C that can be positioned in any suitable location throughout oven appliance 300. For example, controller 510C may be located proximate user interface panel 334 toward a front portion of oven appliance 300.

As shown, controller 510C is communicatively coupled (i.e., in operative communication) with user interface panel 334, including controls 336 and display component 338. Controller 510C may also be communicatively coupled with various operational components of oven appliance 300, such as heating elements (e.g., 326, 332), sensors, etc. Input/output (“I/O”) signals may be routed between controller 510C and the various operational components of oven appliance 300. Thus, controller 510C can selectively activate and operate these various components. Various components of oven appliance 300 are communicatively coupled with controller 510C via one or more communication lines such as, for example, conductive signal lines, shared communication busses, or wireless communications bands.

In some embodiments, oven appliance 300 includes a temperature sensor 338 (e.g., thermistor or thermocouple) communicatively coupled with controller 510C. During use, temperature sensor 338 may be used to measure the temperature at oven appliance 300 (e.g., within cooking chamber 328) and to provide such measurements to controller 510C. Based on the measured temperature, controller 510C can direct heating elements 326, 332. In other words, heating elements 326, 332 may be adjusted depending on the signals received from temperature sensor 338. Although temperature sensor 338 is shown in a particular location in FIG. 2, it will be appreciated that other suitable locations may be used and, if desired, one or more temperature sensors may be applied as well.

In additional or alternative embodiments, an interior camera assembly 342 is mounted to cabinet 310 and communicatively coupled with controller 510C to capture images (e.g., static images or dynamic video) of a portion of oven appliance 300 (e.g., within cooking chamber 328).

Generally, interior camera assembly 342 may be any type of device suitable for capturing a picture or video. As an example, interior camera assembly 342 may be a video camera or a digital camera with an electronic image sensor [e.g., a charge coupled device (CCD) or a CMOS sensor]. Interior camera assembly 342 may be in operable communication with controller 510C such that controller 510C can receive an image signal (e.g., video signal) from interior camera assembly 342 corresponding to the picture(s) captured by interior camera assembly 342. Once received by controller 510C, the image signal (e.g., video signal) may be further processed at controller 510C or transmitted to a separate device (e.g., remote server 404) “live” or in real-time for remote viewing (e.g., via a user device 408).

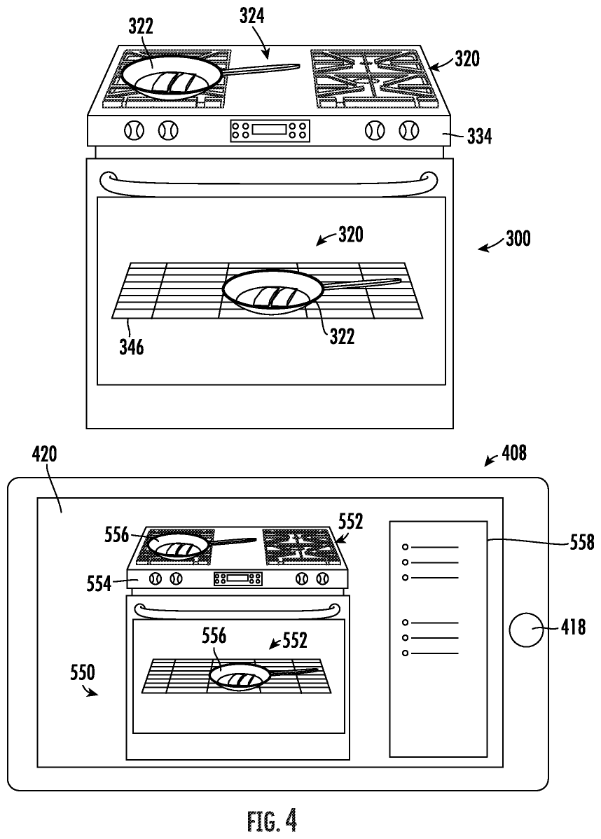

As shown, interior camera assembly 342 may be mounted within cabinet 310. In some embodiments, interior camera assembly 342 is directed at a portion of cooking chamber 328. For instance, interior camera assembly 342 may be mounted within to an upper interior wall of cabinet 310 and directed downward to capture the cooking zone 320 defined by one or more racks 346 within cooking chamber 328, as shown. As would be understood, rack 346 may be positioned (e.g., slidably positioned) in cooking chamber 328 to define a cooking zone 320 for receipt of food items or utensils 332. When assembled, interior camera assembly 342 may thus capture light emitted or reflected from cooking zone 320 through the cooking chamber 328. In some such embodiments, interior camera assembly 342 can selectively capture an image covering all or some of the horizontal support surface define by rack 346. During use, objects (e.g., utensil 322) placed on one of the rack 346 (or otherwise between cooking zone 320 and interior camera assembly 342) may be recorded and transmitted instantly to another portion of system 100 as part of a real-time video feed. Thus, the real-time video feed may include a digital picture or representation 556 of the cooking zone 320 or utensil 322 (e.g., as illustrated in FIG. 4). Optionally, interior camera assembly 342 may be directed such that a line of sight is defined from interior camera assembly 342 that is perpendicular to the horizontal support surface define by rack 346.

In optional embodiments, an oven light or lighting assembly 348 is provided above cooking zone 320 or within cooking chamber 328. For instance, lighting assembly 348 may be mounted to an upper interior wall of cabinet 310 (e.g., directly above cooking zone 320 or rack 346). Generally, lighting assembly 348 includes one or more selectable light sources directed toward cooking chamber 328 (e.g., to illuminate the cooking zone 320 therein). In other words, lighting assembly 348 may oriented to project a light to cooking and illuminate at least a portion of cooking zone 320 or rack 346. The light sources may include any suitable light-emitting elements, such as one or more light emitting diode (LED), incandescent bulb, fluorescent bulb, halogen bulb, etc.

In optional embodiments, a hood assembly 350 having a hood casing 352 is provided. Specifically, hood assembly 350 and hood casing 352 may be spaced apart from cabinet 310 or cooktop surface 324. An open region 130 may thus be defined along the vertical direction V between cabinet 310 or cooktop surface 324 and a bottom portion of hood casing 352. Optionally, hood casing 352 is provided as a range hood. Thus, a ventilation assembly within hood casing 352 may direct an airflow from the open region 130 and through hood casing 352. However, a range hood is provided by way of example only. Other configurations may be used within the spirit and scope of the present disclosure. For example, hood casing 352 could be part of a microwave or other appliance designed to be located above oven appliance 300 (e.g., directly above cooktop surface 324). Moreover, although a generally rectangular shape is illustrated, any suitable shape or style may be adapted to form the structure of hood casing 352.

Generally, a controller 510A may be mounted to hood appliance 350 (e.g., within hood casing 352) to control one or more portions thereof. In some such embodiments, one or more camera assemblies (e.g., an exterior camera assembly 344) are provided to capture images (e.g., static images or dynamic video) of a portion of oven appliance 300 or an area adjacent to oven appliance 300. Generally, the exterior camera assembly 344 may be any type of device suitable for capturing a picture or video. As an example, each exterior camera assembly 344 may be a video camera or a digital camera with an electronic image sensor [e.g., a charge coupled device (CCD) or a CMOS sensor]. A exterior camera assembly 344 is generally provided in operable communication with controller 510A such that controller 510A may receive an image signal (e.g., video signal) from exterior camera assembly 344 corresponding to the picture(s) captured by exterior camera assembly 344. Once received by controller 510A, the image signal (e.g., video signal) may be further processed at controller 510A (e.g., for viewing at image monitor 420) or transmitted to a separate device (e.g., remote server 404) “live” or in real-time for remote viewing (e.g., via one or more social media platforms). Optionally, one or more microphones (not pictured) may be associated with camera assemblies 114A to capture and transmit audio signal(s) coinciding (or otherwise corresponding) with the captured image signal or picture(s).

In some embodiments, exterior camera assembly 344) is directed at a cooking zone 320 on cooktop surface 324. In other words, exterior camera assembly 344 is oriented to capture light emitted or reflected from cooktop surface 324 through the open region 130. In some such embodiments, exterior camera assembly 344 can selectively capture an image covering all or some of cooktop surface 324. For instance, exterior camera assembly 344 may capture an image covering one or more heating elements 326 of oven appliance 300. In some such embodiments, the captured heating elements 326 and any utensil 322 placed on one of the heating elements 326 (or otherwise between cooking zone 320 and exterior camera assembly 344) may be recorded and transmitted instantly to another portion of system 100 (e.g., image monitor 420) as part of a real-time video feed. Thus, the real-time video feed may include a digital picture or representation 556 of the heating elements 326 or utensil 322 (e.g., as illustrated in FIG. 4). Optionally, exterior camera assembly 344 may be directed such that a line of sight is defined from exterior camera assembly 344 that is perpendicular to cooktop surface 324.

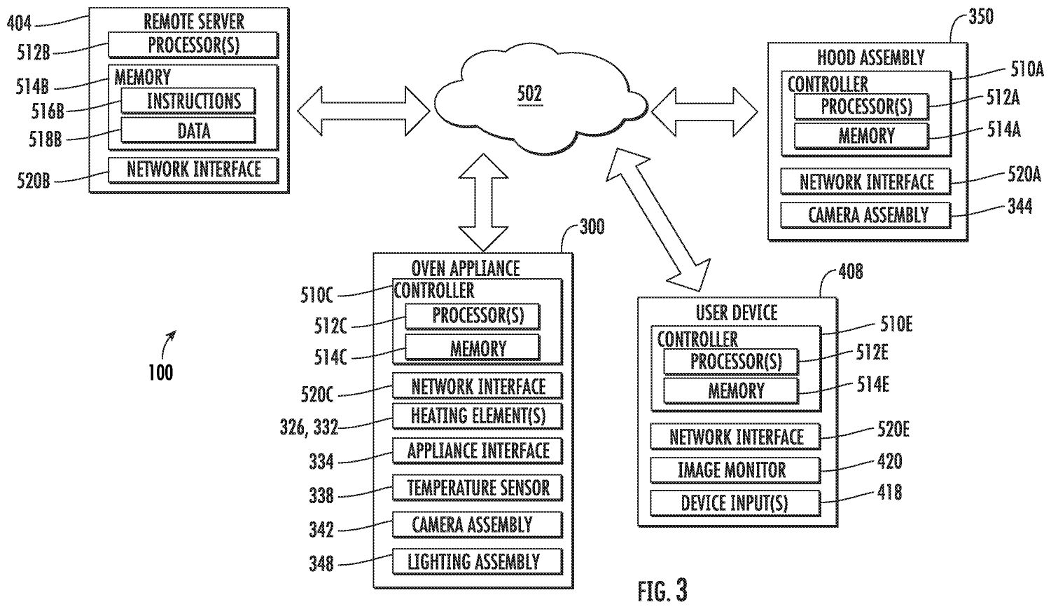

Turning especially to FIG. 3, a schematic view is provided of system 100, illustrating oven appliance 300, hood assembly 350, one or more remote servers 404, and one or more remote user interface devices (e.g., user devices) 408. As shown, oven appliance 300 can be communicatively coupled with a network 502 and various other nodes, such as hood assembly 350, remote server 404, and a user device 408.

In some embodiments, controller 510C includes one or more memory devices 514C and one or more processors 512C. The processors 512C can be any suitable processing device (e.g., a processor core, a microprocessor, an ASIC, a FPGA, a microcontroller, etc.) and can be one processor or a plurality of processors that are operatively connected and can execute programming instructions or control code associated with operation of oven appliance 300. The memory devices 514C (i.e., memory) can include one or more non-transitory computer-readable storage mediums, such as RAM, ROM, EEPROM, EPROM, flash memory device, magnetic disks, etc., and combinations thereof. The memory devices 514C can store data and instructions that are executed by the processor 512C to cause oven appliance 300 to perform operations. In some embodiments, the processor 512C executes programming instructions stored in memory 514C. The memory 514C may be a separate component from the processor 512C or may be included onboard within the processor 512C.

Controller 510C includes a network interface 520C such that controller 510C can connect to and communicate over one or more networks (e.g., network 502) with one or more network nodes. Controller 510C can also include one or more transmitting, receiving, or transceiving components for transmitting/receiving communications with other devices communicatively coupled with oven appliance 300. Additionally or alternatively, one or more transmitting, receiving, or transceiving components can be located off board for controller 510C.

Network 502 can be any suitable type of network, such as a local area network (e.g., intranet), wide area network (e.g., internet), low power wireless networks [e.g., Bluetooth Low Energy (BLE)], or some combination thereof and can include any number of wired or wireless links. In general, communication over network 502 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

In optional embodiments, hood assembly 350 includes a controller 510A operably coupled to exterior camera assembly 344. Controller 510A may include one or more processors 512A and one or more memory devices 514A (i.e., memory). The one or more processors 512A can be any suitable processing device (e.g., a processor core, a microprocessor, an ASIC, a FPGA, a microcontroller, etc.) and can be one processor or a plurality of processors that are operatively connected. The memory device 514A can include one or more non-transitory computer-readable storage mediums, such as RAM, ROM, EEPROM, EPROM, flash memory device, magnetic disks, etc., and combinations thereof. The memory devices 514A can store data and instructions that are executed by the processor 512A to cause hood assembly 350 to perform operations.

Controller 510A may include a network interface 520A such that hood assembly 350 can connect to and communicate over one or more networks (e.g., network 502) with one or more network nodes. Network interface 520A can be an onboard component of controller 510A or it can be a separate, off board component. Controller 510A can also include one or more transmitting, receiving, or transceiving components for transmitting/receiving communications with other devices communicatively coupled with hood assembly 350. Additionally or alternatively, one or more transmitting, receiving, or transceiving components can be located off board for controller 510A.

In some embodiments, a remote server 404, such as a web server, is in operative communication with oven appliance 300 or hood assembly 350. The server 404 can be used to host an information database (e.g., recipe database, historical appliance use database, etc.). The server 404 can be implemented using any suitable computing device(s). The server 404 may include one or more processors 512B and one or more memory devices 514B (i.e., memory). The one or more processors 512B can be any suitable processing device (e.g., a processor core, a microprocessor, an ASIC, a FPGA, a microcontroller, etc.) and can be one processor or a plurality of processors that are operatively connected. The memory device 512B can include one or more non-transitory computer-readable storage mediums, such as RAM, ROM, EEPROM, EPROM, flash memory devices, magnetic disks, etc., and combinations thereof. The memory devices 514B can store data 518B and instructions 516B which are executed by the processor 512B to cause remote server 404 to perform operations. For example, instructions 516B could be instructions for receiving/transmitting images or image signals, transmitting/receiving recipe signals, etc.

In some embodiments, a remote server 404, such as a web server, is in operative communication with oven appliance 300. The server 404 can be used to host an information database (e.g., recipe or instruction database, historical appliance use database, etc.). The server can be implemented using any suitable computing device(s). The server 404 may include one or more processors 512B and one or more memory devices 514B (i.e., memory). The one or more processors 512B can be any suitable processing device (e.g., a processor core, a microprocessor, an ASIC, a FPGA, a microcontroller, etc.) and can be one processor or a plurality of processors that are operatively connected. The memory device 512B can include one or more non-transitory computer-readable storage mediums, such as RAM, ROM, EEPROM, EPROM, flash memory devices, magnetic disks, etc., and combinations thereof. The memory devices 514B can store data 518B and instructions 516B which are executed by the processor 512B to cause remote server 404 to perform operations. For example, instructions 516B could be instructions for receiving/transmitting images or image signals, transmitting/receiving control signals, etc.

The memory devices 514B may also include data 518B, such as input data, notification data, message data, image data, etc., that can be retrieved, manipulated, created, or stored by processor 512B. The data 518B can be stored in one or more databases. The one or more databases can be connected to remote server 404 by a high bandwidth LAN or WAN, or can also be connected to remote server 404 through network 502. The one or more databases can be split up so that they are located in multiple locales.

Remote server 404 includes a network interface 520B such that remote server 404 can connect to and communicate over one or more networks (e.g., network 502) with one or more network nodes. Network interface 520B can be an onboard component or it can be a separate, off board component. In turn, remote server 404 can exchange data with one or more nodes over the network 502. In particular, remote server 404 can exchange data with oven appliance 300, hood assembly 350, or user device 408. Although not pictured, it is understood that remote server 404 may further exchange data with any number of client devices over the network 502. The client devices can be any suitable type of computing device, such as a general purpose computer, special purpose computer, laptop, desktop, integrated circuit, mobile device, smartphone, tablet, or other suitable computing device.

In certain embodiments, a user device 408 is communicatively coupled with network 502 such that user device 408 can communicate with oven appliance 300. For instance, user device 408 can communicate directly with oven appliance 300 via network 502. Alternatively, user device 408 can communicate indirectly with oven appliance 300 by communicating via network 502 with remote server 404 (e.g., directly or indirectly through one or more intermediate remote servers), which in turn communicates with oven appliance 300 via network 502.

User device 408 can be any type of device, such as, for example, a personal computing device (e.g., laptop or desktop), a mobile computing device (e.g., smartphone or tablet), a gaming console or controller, a wearable computing device, an embedded computing device, a remote, or any other suitable type of user computing device. User device 408 can include one or more user device 408 controllers 510E. Controller 510E can include one or more processors 512E and one or more memory devices 514E. The one or more processors 512E can be any suitable processing device (e.g., a processor core, a microprocessor, an ASIC, a FPGA, a controller, a microcontroller, etc.) and can be one processor or a plurality of processors that are operatively connected. The memory device (i.e., memory) can include one or more non-transitory computer-readable storage mediums, such as RAM, ROM, EEPROM, EPROM, flash memory devices, magnetic disks, etc., and combinations thereof. The memory can store data and instructions which are executed by the processor 512E to cause user device 408 to perform operations. Controller 510E may include a network interface 520E such that user device 408 can connect to and communicate over one or more networks (e.g., network 502) with one or more network nodes. Network interface 520E can be an onboard component of controller 510E or it can be a separate, off board component. Controller 510E can also include one or more transmitting, receiving, or transceiving components for transmitting/receiving communications with other devices communicatively coupled with user device 408. Additionally or alternatively, one or more transmitting, receiving, or transceiving components can be located off board for controller 510E.

Generally, a user may be in operative communication with oven appliance 300 or one or more user devices 408. For instance, a user may wish to alternately operate oven appliance 300 directly (e.g., through inputs 336) or remotely (e.g., through user device 408). In particular, a user may wish to control operational features that include activating portions of oven appliance 300, selecting a temperature or heat setting for oven appliance 300 (e.g., adjusting a temperature setting for a heating element 326, 332), illuminating cooking chamber 328, etc.

Turning now especially to FIG. 4, user device 408 includes a device interface 418 having one or more user inputs such as, for example, buttons, one or more cameras, or a monitor configured to display graphical user interfaces or other visual representations to user. For example, the device interface 418 can include an image monitor 420. Generally, image monitor 420 may be any suitable type of mechanism for visually presenting a digital image. For example, image monitor 420 may be a liquid crystal display (LCD) panel, an organic light emitting diode (OLED) panel, etc. Thus, image monitor 420 includes an imaging surface (e.g., screen or display panel) at which the digital image is presented or displayed as an optically-viewable picture (e.g., static image, dynamic or moving video, etc.) to a user. The optically-viewable picture may correspond to any suitable signal or data received or stored by oven appliance 300 (e.g., at controller 510C) or hood assembly 350 (e.g., at controller 510A).

As an example, image monitor 420 may selectively present a graphical user interface (GUI) that allows a user to select or manipulate various operational features of oven appliance 300. In particular, the GUI may include an interactive oven avatar 550 as a virtual representation (e.g., controller-generated object presented on image monitor 420) of oven appliance 300. During use, control inputs received at oven avatar 550 (e.g., from user input or engagement with image monitor 420) may be relayed or transmitted to oven appliance 300 (e.g., via remote server 404—FIG. 3). Moreover, during use of such GUI embodiments, a user may engage, select, or adjust the image presented at image monitor 420 through any suitable input, such as gesture controls, voice controls detected through one or more microphones, associated touch panels (e.g., capacitance or resistance touch panels) or sensors overlaid across imaging surface, etc.

As illustrated, the oven avatar 550 may generally mirror the appearance of oven appliance 300 and may provide or include a virtual three-dimensional model of the oven appliance 300 (e.g., that is viewable in two dimensions on image monitor 420). Various virtual portions defined on the computer generated model or oven avatar 550 may thus correspond to physical portion portions of oven appliance 300. For instance, the oven avatar 550 may include a virtual zone 552 that corresponds to the cooking zone 320 of cooking chamber 328 or cooktop 324. Additionally or alternatively, the oven avatar 550 may include a virtual interface panel 554 that corresponds to the user interface panel 334. Further additionally or alternatively, the GUI may include a separate (e.g., text based) panel 558 that, for example, may provide information or input selections regarding oven appliance 300 (e.g., temperature settings for heating elements 326 or 332, temperature measurements from temperature sensor 338, a timer, heating element status, etc.).

In some embodiments, oven avatar 550 includes or presents a remotely captured image, such as a live (e.g., real-time) dynamic video stream, at the virtual zone 552. Thus, the real-time video feed may include a digital picture or representation 556 of a cooking zone 320 or utensils 322 therein. In particular, the displayed real-time feed may map the image captured at a camera assembly (e.g., camera assembly 342 or camera assembly 344) onto the virtual zone 552, advantageously providing an intuitive representation of the oven appliance 300. Moreover, a user may be able to advantageously monitor the status of cooking zone 320 (e.g., cooking progress, presence of utensil 322, illumination/feedback of lighting assembly 348, etc.), which may further confirm connection and communication between oven appliance 300 and remote device.

In additional or alternative embodiments, oven avatar 550 is configured to receive user or control inputs at virtual interface panel 554. During use, a user may manipulate virtual buttons or knobs on virtual interface panel 554 (e.g., via touch panel engagement with image monitor 420) to control the same corresponding functions of oven appliance 300. For instance, a user may manipulate virtual buttons or knobs on virtual interface panel 554 that mirror actual buttons or knobs on user interface panel 334. Manipulating virtual temperature control buttons may thus initiate the transfer of control input signals to oven appliance 300 such that oven appliance 300 is directed accordingly. In other words, manipulating virtual temperature buttons may have the same effect to adjust a heating element 326 or 332 as manipulating the actual temperature buttons (e.g., to adjust the current temperature of cooking chamber 328 by raising/lowering the heat generated at one or more heating elements 326, 332). Additionally or alternatively, manipulating virtual light buttons may have the same effect as manipulating the actual light buttons (e.g., to activate/deactivate lighting assembly 348 and illuminate/darken cooking chamber 328).

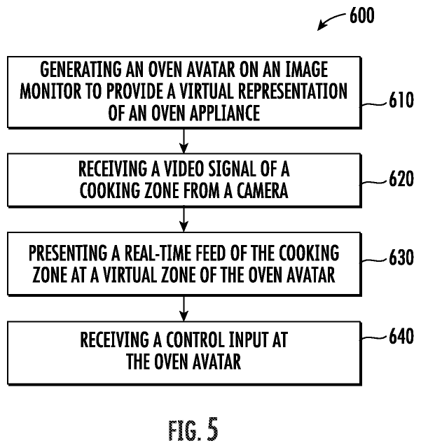

Referring now to FIG. 5, various methods may be provided for use with system 100 in accordance with the present disclosure. In general, the various steps of methods as disclosed herein may, in exemplary embodiments, be performed by the controller 510E (FIG. 3) as part of an operation that the controller 510E is configured to initiate (e.g., a directed cooking operation). During such methods, controller 510E may receive inputs and transmit outputs from various other components of the system 100. For example, controller 510E may send signals to and receive signals from remote server 404, oven appliance 300, or hood assembly 350, as well as other components within user device 408 (FIG. 4). In particular, the present disclosure is further directed to methods, as indicated by 600, for operating the system 100. Such methods advantageously facilitate intuitive, remote monitoring of oven appliance 300. In certain embodiments, such methods may advantageously facilitate easy-to-understand, augmented-reality use of oven appliance 300.

At 610, the method 600 includes generating an oven avatar on the image monitor to provide a virtual representation of the oven appliance. In particular, the oven avatar includes a virtual zone corresponding to a cooking zone of the oven appliance. As described above, the oven avatar may provide a controller or computer generated model, such as a virtual three-dimensional model of the oven appliance. Thus, the virtual zone may be defined on the virtual three-dimensional model. Additionally or alternatively, the oven avatar may include a virtual interface panel defined on the virtual three-dimensional model. Specifically, the virtual interface panel may correspond to (e.g., mirror or otherwise provide a recognizable model of) the control panel of the oven appliance, which may be mounted to a cabinet of the oven appliance.

At 620, the method 600 includes receiving a video signal of the cooking zone of the oven appliance from a camera or camera assembly. In some embodiments, the cooking zone is provided within a cooking chamber defined within a cabinet of the oven appliance, as described above. For instance, the cooking zone may be defined on a rack within the cooking chamber. In some such embodiments, the camera is mounted to the cabinet within the cooking chamber (e.g., at an upper interior wall). In additional or alternative embodiments, the cooking zone is a cooktop mounted to a top portion of a cabinet of the oven appliance, as also described above. In some such embodiments, the camera is mounted above the cooktop (e.g., to a hood casing directly above cooktop).

As would be understood, the video signal may include multiple sequenced images captured by a camera assembly. In some embodiments, the captured video signal is transmitted in real-time (e.g., continuously or instantly). For instance, the video signal may be received by the controller of the oven appliance or another node of the system (e.g., the remote server) before being transmitted to the user device. Optionally, a real-time dynamic video signal or stream may be transmitted based on a view or image detected at the camera assembly. Additionally or alternatively, multiple image signals (e.g., separate image signals or streams from multiple discrete camera assemblies) may be transmitted simultaneously.

At 630, the method 600 includes presenting a real-time feed of the cooking zone at the virtual zone of the oven avatar. Thus, the oven avatar may provide a live video stream mapped onto the oven avatar on the image monitor of the user device, as described above.

At 640, the method 600 includes receiving a control input at the oven avatar. In some embodiments, the control input is received at a virtual interface panel of the oven avatar. Additionally or alternatively, control inputs may be received at other portions of the graphical user interface provided, for instance, at the image monitor of the user device. Further additionally or alternatively, one or more data signals (e.g., corresponding to information detected at the oven appliance, such as the temperature of cooking chamber, cooktop, etc.) may be received at the user device and presented as part of the graphical user interface.

At 650, the method 600 includes directing the oven appliance based on the control input received at the oven avatar on the remote user device. As an example, 650 may include initiating illumination of an oven light source directed at the cooking zone. As an additional or alternative example, 650 may include adjusting a current cooking temperature of the cooking zone.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of operating an oven appliance at a remote user interface device in wireless communication with the oven appliance, the oven appliance comprising a cooking zone and a camera directed at the cooking zone, the remote user interface device comprising an image monitor, the method comprising:
generating an oven avatar on the image monitor to provide a virtual representation of the oven appliance, the oven avatar comprising a virtual zone corresponding to the cooking zone to provide an illustrated position of the cooking zone on the oven appliance;
receiving a video signal of the cooking zone from the camera;
presenting a real-time feed of the cooking zone at the virtual zone;
receiving a control input at the oven avatar; and
directing the oven appliance based on the control input received at the oven avatar on the remote user interface device,
wherein the oven avatar comprises a virtual three-dimensional model of the oven appliance viewable in two dimensions on the image monitor, and wherein the virtual zone is defined on the virtual three-dimensional model as a real-time representation of the cooking zone, the real-time representation of the cooking zone being mapped onto the virtual zone to contain the real-time representation within the illustrated position of the cooking zone on the oven appliance.

2. (canceled)

3. The method of claim 1, wherein the oven avatar further comprises a virtual interface panel defined on the virtual three-dimensional model, wherein the virtual interface panel corresponds to a control panel mounted to a cabinet of the oven appliance, and wherein the control input is received at the virtual interface panel.

4. The method of claim 1, wherein directing the oven appliance comprises initiating illumination of an oven light source directed at the cooking zone.

5. The method of claim 1, wherein directing the oven appliance comprises adjusting a current cooking temperature of the cooking zone.

6. The method of claim 1, wherein the cooking zone is within a cooking chamber defined within a cabinet of the oven appliance.

7. The method of claim 6, wherein the camera is mounted to the cabinet within the cooking chamber.

8. The method of claim 1, wherein the cooking zone is a cooktop mounted to a top portion of a cabinet of the oven appliance.

9. The method of claim 8, wherein the camera is mounted above the cooktop.

10. A user engagement system comprising:
a camera assembly directed at a cooking zone of an oven appliance;
an image monitor spaced apart from the cooking zone; and
a controller in operative communication with the camera assembly and the image monitor, wherein the controller is configured to initiate a directed cooking operation, the directed cooking operation comprising:
generating an oven avatar on the image monitor to provide a virtual representation of the oven appliance, the oven avatar comprising a virtual zone corresponding to the cooking zone to provide an illustrated position of the cooking zone on the oven appliance,
receiving a video signal of the cooking zone from the camera assembly,
presenting a real-time feed of the cooking zone at the virtual zone,
receiving a control input at the oven avatar, and
directing the oven appliance based on the control input received at the oven avatar on the remote user interface device,
wherein the oven avatar comprises a virtual three-dimensional model of the oven appliance viewable in two dimensions on the image monitor, and wherein the virtual zone is defined on the virtual three-dimensional model as a real-time representation of the cooking zone, the real-time representation of the cooking zone being mapped onto the virtual zone to contain the real-time representation within the illustrated position of the cooking zone on the oven appliance.

11. (canceled)

12. The user engagement system of claim 10, wherein the oven avatar further comprises a virtual interface panel defined on the virtual three-dimensional model, wherein the virtual interface panel corresponds to a control panel mounted to a cabinet of the oven appliance, and wherein the control input is received at the virtual interface panel.

13. The user engagement system of claim 10, wherein directing the oven appliance comprises initiating illumination of an oven light source directed at the cooking zone.

14. The user engagement system of claim 10, wherein directing the oven appliance comprises adjusting a current cooking temperature of the cooking zone.

15. The user engagement system of claim 10, wherein the cooking zone is within a cooking chamber defined within a cabinet of the oven appliance.

16. The user engagement system of claim 15, wherein the camera assembly is mounted to the cabinet within the cooking chamber.

17. The user engagement system of claim 10, wherein the cooking zone is a cooktop mounted to a top portion of a cabinet of the oven appliance.

18. The user engagement system of claim 17, wherein the camera assembly is mounted above the cooktop.

19. A user engagement system comprising:
a camera assembly directed at a cooking zone of an oven appliance, the oven appliance comprising a cabinet defining the cooking zone and a control panel mounted to the cabinet;
an image monitor spaced apart from the cooking zone; and
a controller in operative communication with the camera assembly and the image monitor, wherein the controller is configured to initiate a directed cooking operation, the directed cooking operation comprising:
generating an oven avatar on the image monitor to provide a virtual representation of the oven appliance, the oven avatar comprising a virtual zone corresponding to the cooking zone to provide an illustrated position of the cooking zone on the oven appliance,
receiving a video signal of the cooking zone from the camera assembly,
presenting a real-time feed of the cooking zone at the virtual zone,
receiving a control input at the oven avatar, and
directing the oven appliance based on the control input received at the oven avatar on the remote user interface device,
wherein the oven avatar comprises a virtual three-dimensional model of the oven appliance viewable in two dimensions on the image monitor and a virtual interface panel defined on the virtual three-dimensional model, wherein the virtual zone is defined on the virtual three-dimensional model as a real-time representation of the cooking zone, the real-time representation of the cooking zone being mapped onto the virtual zone to contain the real-time representation within the illustrated position of the cooking zone on the oven appliance, and wherein the control input is received at the virtual interface panel.

20. The user engagement system of claim 19, wherein directing the oven appliance comprises initiating illumination of an oven light source directed at the cooking zone.

21. The user engagement system of claim 19, wherein directing the oven appliance comprises adjusting a current cooking temperature of the cooking zone.
